(19) United States
(12) Patent Application Publication
(10) Pub. No.: US 2007/0029370 A1
(43) Pub. Date: Feb. 8, 2007

(54) Kinetic spray deposition of flux and braze alloy composite particles

(76) Inventors: Zhibo Zhao, Novi, MI (US); Bryan A. Gillispie, Macomb Township, MI (US); Michael John Irish, Getzville, NY (US); John Stanley Rosen JR., Williamsville, NY (US)

Correspondence Address: DELPHI TECHNOLOGIES, INC., M/C 480-410-202, PO BOX 5052, TROY, MI, 48007, US

(21) Appl. No.: 11/198,981

(22) Filed: Aug. 8, 2005

(51) Int. Cl. B23K 35/12; B23K 31/02

(52) U.S. Cl. 228/261; 228/223

(57) ABSTRACT

The present invention is directed to a process for preparing substrates, such as aluminum and aluminum alloy surfaces in heat exchangers, for brazing by depositing thereon a kinetic sprayed brazing composition. The process simultaneously deposits composite particles that include all braze materials, i.e., both filler alloy and brazing flux, and corrosion protection materials used in the brazing of aluminum fins to plates and tubes in a single stage.

### TECHNICAL FIELD

The present invention is directed to a process for preparing aluminum and aluminum alloy and other metal tubes, plates and other components used in heat exchangers such as condensers, radiators and evaporators for brazing by depositing thereon a kinetic sprayed brazing composition. In accordance with particular embodiments, the process involves depositing coatings containing composite particles that comprise a corrosion protector, a brazing filler and a brazing flux to a substrate in preparation for brazing.

### INCORPORATION BY REFERENCE

U.S. Pat. No. 6,139,913, entitled “Kinetic Spray Coating Method and Apparatus” and U.S. Pat. No. 6,821,558, entitled “Method for Direct Application of Flux to a Brazing Surface” are incorporated by reference herein.

### BACKGROUND OF THE INVENTION

Heat exchangers such as condensers, radiators, evaporators, heater cores and coolers made of aluminum or aluminum alloy (generally referred to hereinafter as “aluminum”) or other metals are widely used today. These heat exchangers generally include perforated fins brazed to the external surfaces of tubes and plates that form the structure of the heat exchanger. The tubes are usually extruded and the fins are usually made from sheets.

Prior to assembling into heat exchangers the tubes and plates are typically coated (or plated) with a corrosion protector using known techniques such as twin-wire arc thermal spraying. Zinc or zinc-aluminum alloys are generally used as the corrosion protector, but any known corrosion inhibitor may be used. The fins are prepared prior to assembling to carry the brazing filler that forms the joints between the tube and fins during brazing. The brazing filler is applied to fin sheet stock as a cladding layer in the form of an overlaid sheet that is rolled and bonded onto the aluminum fin sheet. The cladding consists of a material or materials known in the art to be capable of melting at a temperature lower than the heat exchanger aluminum such as an aluminum-silicon alloy so that, during brazing, the cladding will form brazed joints. The use of such clad brazing sheets is well known and commonly used, even though it is well known that the use of clad brazing sheets adds to production costs and accelerates tool wear.

Prior to brazing of aluminum heat exchangers, tube cladding and plate surfaces must be cleaned and de-oxidized. Removal of the oxidation layer is necessary in order to form strong joints. This is generally accomplished using a material commonly known as flux that chemically cleans and de-oxidizes the surface and protects the aluminum from further oxidation. The flux is applied to the aluminum surfaces of plates and tubes prior to brazing using techniques such as flux showering or electrostatic spraying the entire tube-fin assemblies. During brazing, the flux material further serves to reduce the filler metal's surface tension and promote wetting of the materials to assist in joint formation. While many flux materials are known and used, NOCOLOK® Flux (a mixture of potassium fluoroaluminate salts manufactured by Solvay Fluor), and similarly formulated fluxes, are preferred due to their non-corrosive effect on aluminum after brazing. The components of the heat exchanger are finally joined together by bringing the assembly to brazing temperature in a controlled atmosphere brazing furnace, a vacuum furnace, or the like.

Controlled Atmosphere Brazing (CAB) is commonly used for manufacturing condensers and other types of heat exchangers. The Al brazing process involves joining of components with a brazing alloy whose melting point is lower than that of the components. Because Al components have intrinsically tenacious Al oxide surface layers, a brazing flux is indispensable for formation of good brazing joints. The most commonly used brazing flux in Al brazing industry is NOCOLOK® Flux. This type of flux, typically in the form of fine white powder, contains primarily a mixture of potassium fluoraluminates. The main phase is potassium tetra-fluoraluminates (KAlF₄), along with a small amount of potassium penta-fluoroaluminate (K₂AlF₅). Often K₂AlF₅ exists in different forms: potassium penta-fluoroaluminate hydrate (K₂AlF₅·H₂O) and hydrate-free (K₂AlF₅). During the brazing process, the material undergoes several physico-chemical alterations, as briefly described below.

At the low temperature stage of a brazing process, the main component of flux KAlF₄ is simply heated up and the compound K₂AlF₅·H₂O begins to lose its crystal water at temperatures above 90° C. When the furnace temperature is raised above 350° C. (660° F.), K₂AlF₅ begins to decompose according to the equation:
2 K₂AlF₅→KAlF₄+K₃AlF₆ (1)

This is an important reaction, because it generates the exact amount of potassium hexafluoraluminate (K₃AlF₆) necessary for a eutectic flux composition with KAlF₄, based on the phase diagram of KF-AlF₃. The resulting flux composition has a well-defined melting range of 565° C. to 572° C., at which the flux melts to a colorless liquid that wets at faying surfaces of the Al components for brazing.

In current manufacturing practice, the brazing flux is applied to each entire unit of the fin-tube assemblies by spraying an aqueous slurry or by electrostatic spraying of the dry flux. Both approaches require expensive capital equipment that occupies a large floor plan and involves tedious procedures. In the case of slurry application, the process involves spraying the flux-water solution onto the assembled units, air blowing-off of water and baking/drying operations. All these steps take place sequentially prior to the brazing operation. Such a flux applying process also involved wastewater treatment, which poses environmental challenges and increases the product cost.

Moreover, since the flux is sprayed (either slurry or dry) onto the entire assembly unit, the resulting flux powder is distributed all over the exposed surfaces, including those of the corrugated fins and the extruded tubes. However, most of the adhered flux is not needed, since the brazing action occurs only at localized areas where the fin tips contact the extruded tubes. In other words, only a very small fraction of the flux applied to the fin-tube assembly is actually engaged in assisting formation of braze joints. The excessive use of flux in spraying each entire assembly not only adds material cost to the manufacturing process, but also has other undesired consequences. During the brazing process, for example, the brazing flux becomes a liquid and in excess tends to drip from the fin-tube assemblies. This liquid can form rock-hard flux residues inside the brazing furnace, which require the furnace to be cleaned more frequently. Therefore, it is very desirable to develop a process that can eliminate the procedure of applying flux.

To summarize, aluminum heat exchangers for automotive vehicles and other applications, today, are typically manufactured by flux brazing of filler-clad fin sheets to zinc-coated plates and tubes. The fin sheets are clad with brazing filler in one process, the plates and tubes are coated with zinc in a second process and the brazing flux is applied in a third process.

An alternative method of preparing heat exchanger components for aluminum brazing is disclosed in U.S. Pat. No. 5,907,761. In the '761 patent, a solvent-based brazing composition is coated onto components using known techniques such as dip coating or liquid spray coating. The disclosed brazing composition includes, (1) a powdered alloy of aluminum, silicon, zinc, and indium (or beryllium), (2) a polymeric resin binder, (3) an aliphatic alcohol solvent, and (4) a brazing flux. In the patent, an alloy is first formed from powders of aluminum, silicon, zinc and indium. The alloy is then made into a powder and mixed with the polymer binder, solvent and flux. The resulting liquid brazing composition is then applied to the substrate using known techniques and becomes bound to the substrate by action of the polymer resin. Brazing follows.

### SUMMARY OF THE INVENTION

By the process of the present invention, substrates such as aluminum are prepared for brazing using a new technique that replaces the multi-step operations of the prior art. The present invention in accordance with certain embodiments provides a means to simultaneously clean and deoxidize heat exchanger components and bond all braze materials onto the components in a single operation. Individual zinc plating, filler cladding and separate flux application (for pre-cleaning, deoxidizing and braze flux deposition) can thereby be replaced. In addition, no solvent base or other liquid system is necessary.

The present invention generally applies a new technique for producing coatings known as kinetic spray or cold gas dynamic spray to brazing. This new technology has been reported in an article by T. H. Van Steenkiste et al., entitled “Kinetic Spray Coatings,” published in Surface and Coatings Technology, vol. 111, pages 62-71, Jan. 10, 1999, the contents of which are hereby incorporated by reference. The article discusses producing layer coatings (continuous or non-continuous) having low porosity, high adhesion, low oxide content and low thermal stress. The article describes coatings being produced by entraining metal powders in an accelerated air stream and projecting them against a target substrate. It was found that the particles that formed the coating did not melt prior to impingement onto the substrate.

The Van Steenkiste et al. work improved upon earlier work by Alkimov et al. as disclosed in U.S. Pat. No. 5,302,414, issued Apr. 12, 1994. Alkimov et al. disclosed an apparatus and process for producing dense layer coatings with powder particles having a particle size of from 1 to 50 microns using a supersonic spray operating at relatively low temperatures and pressures.

The Van Steenkiste et al. article reported on work conducted by the National Center for Manufacturing Sciences (NCMS) to improve on the earlier Alkimov process and apparatus. Van Steenkiste et al. demonstrated that Alkimov's apparatus and process could be modified to produce kinetic sprayed continuous layer coatings using particle sizes of greater than 50 microns and up to about 106 microns. This modified process and apparatus for producing such larger particle size kinetic spray continuous layer coatings is disclosed in U.S. Pat. No. 6,139,913, Van Steenkiste et al., that issued on Oct. 31, 2000. The process and apparatus provide for heating a high pressure air flow up to about 800° C. and accelerating it with entrained particles through a de Laval-type nozzle to an exit velocity of between about 300 m/s (meters per second) to about 1000 m/s. The thus accelerated particles are directed toward and impact upon a target substrate with sufficient kinetic energy to impinge the particles to the surface of the substrate. The temperatures and pressures used are sufficiently lower than that necessary to cause particle melting so that no phase transformation occurs in the particles prior to impingement.

The present invention provides a method for replacing, with a single process, the several processes currently used in brazing heat exchangers such as condensers, radiators, evaporators, and the like. The single spraying operation can generate a single layer or multiple layers of a brazing composition containing composite particles. Of course, the present invention is not limited to a single step process but a single spraying operation is one of the more efficient methods for practicing the invention.

In accordance with one aspect, the invention involves kinetic spraying onto metal substrates a brazing composition containing composite particles wherein each of the composite particles comprises corrosion protector, brazing filler and flux. In a particular embodiment, the composite particles in the brazing composition comprise zinc or zinc-aluminum alloy as a corrosion protector, silicon or aluminum-silicon alloy as a brazing filler, and NOCOLOK® Flux or similar fluxing material as the flux. In another embodiment, the brazing composition comprises a ternary alloy of aluminum-zinc-silicon powder and flux. Note that in this case the alloy constitutes both the filler ingredient and the corrosion protector. In yet another embodiment, the brazing composition contains composite particles comprising a homogeneous blend of aluminum, zinc, silicon and flux. In accordance with another embodiment, the composite particles comprise a core comprising aluminum, zinc and silicon wherein the surface of the core is coated with flux.

The process of the present invention may be used for brazing any metal surface and is not limited to use in heat exchangers. One advantage of the present invention is that it offers a simple yet versatile process for brazing metal surfaces.

The process provides an effective means for coating a brazing composition onto aluminum substrates that obviates the need for pre-fluxing, filler cladding and separate corrosion protector application. The process of the present invention may be used advantageously during any stage of processing including, for example, from immediately following tube extrusion to immediately prior to brazing.

Kinetic spray deposition is a relatively new technique where powders, especially of metal (or ceramic) particles, are accelerated in a pre-heated gas stream toward a substrate at high velocities between about 300 m/s (meters per second) to about 1000 m/s. Upon impact, the metal particles initially grit blast the surface and then plastically deform and impinge bond onto the surface. Subsequent particles bond with the deposited particles upon impact to form a surface layer coating.

In order for the powder particles to stick to the substrate and become a part of the growing coating, their kinetic energy must be converted to heat or strain energy via plastic deformation during the collision event. The particle velocity at the collisions is considered as the most critical variable that controls the coating formation. Generally, there is a critical particle velocity for a given material to be sprayed; only above which the particles will stick to the substrate and below which the particle will bounce off. Since the plastic deformability of the sprayed particles is the key requisite for forming a coating by the kinetic spray process, brazing flux powder cannot be deposited onto Al substrates by this coating process (for all practical purpose, there is no other known coating processes can spray brazing flux either). This is because in nature the braze flux KAlF₄ is a ceramic compound and can be hardly deformed plastically. In addition, the flux particles (sub-microns to several microns) are not within the particle size range suitable for the kinetic spray process. It has been experimentally confirmed that brazing flux alone cannot be directly deposited by the kinetic spray process.

Prior to the present invention, it was unexpected that kinetic spray could be suitably used to deposit braze compositions containing all of the components for brazing in the form of composite particles onto aluminum surfaces in a manner that would produce satisfactory braze joints. The process as used in the present invention applies the kinetic spray technology similar to that disclosed in U.S. Pat. No. 6,139,913, the disclosure of which is incorporated herein by reference, to the preparation of aluminum surfaces for brazing.

The kinetic sprayed braze compositions are advantageous in that the aluminum components being coated need not be pre-fluxed (i.e., pre-cleaned and deoxidized) since the initial grit blasting action during the kinetic spray process inherently cleans and de-oxidizes the surface as the brazing composition surface layer is being applied. Furthermore, while inert atmosphere processing is generally required for thermal spraying, as used in prior art processes to lessen the formation of oxidation during coating deposition, an inert atmosphere is not necessary in kinetic spray deposition, and the associated costs are thereby avoided.

One benefit of the present invention is the ability to mix different materials having different properties together and apply them as composite particles into a single coating via a single step spray operation. Because the powders are not melted in the kinetic spray process, the materials do not chemically react or engage in alloying in the kinetic spray process. The synergistic benefits and functional integrities of the various materials may, thereby, be taken advantage of in the most effective and efficient manner.

In development of the present invention, it was further discovered that kinetic spray is useful in coating alloys onto aluminum surfaces that have a substantially greater hardness than aluminum. It has now been found that ternary alloys such as zinc-aluminum-silicon alloys may be kinetic spray-coated onto aluminum substrates such as plate and tube surfaces. While specific materials are disclosed herein, it is clear from the versatility of the present invention that alloys of other braze materials may be similarly used.

Using the process of the present invention in aluminum brazing, any conceivable brazing composition may now be used as a single stage coating. Pre-fluxing and the use of a separate flux coating are no longer required. Instead, cleaning and deoxidizing are accomplished simultaneously to coating, and brazing flux is incorporated into the composite particles of the coating itself. Accordingly, fluxing-less brazing is now possible. The term “fluxing-less” as used herein refers to eliminating the separate step of applying flux, not eliminating of the use of flux. The present process also allows the incorporation of brazing filler into the coating so that cladding is no longer required. Accordingly, cladless brazing is now also possible. Furthermore, the corrosion protector is already included in the filler alloy as an alloying element. Thus, the thermal spraying of corrosion protector such as Zn or Zn—Al alloy, which is necessary in prior art, can be eliminated as a result of the present invention. The brazing composition can comprise monoliths or composites of individual powders, alloy powders or their combinations to provide maximum versatility.

Cladless and fluxing-less brazing are now possible and a pre-coating of a corrosion protector is no longer necessary. The present invention provides the ability to incorporate corrosion protector, brazing filler and flux into a single coating composition and the means for coating that composition onto aluminum surfaces while simultaneously cleaning and deoxidizing the surface.

### BRIEF DESCRIPTION OF THE DRAWINGS

FIG. 1 is a schematic layout illustrating a kinetic spray system for using the nozzle of the present invention;

FIG. 2 is a cross-sectional view of a kinetic spray nozzle useful in the present invention;

FIGS. 3A and 3B are SEM images of composite particles of aluminum, zinc, silicon and flux in accordance with one aspect of the present invention;

FIGS. 4A and 4B are SEM images of composite particles compressing an aluminum and silicon core having flux glued to the surface of the core; and

FIGS. 5A and 5B are examples of the joints brazed according to the present invention.

### DETAILED DESCRIPTION OF THE INVENTION

The kinetic spray technique used in the present invention is primarily as disclosed in U.S. Pat. Nos. 6,139,913, 6,283,386 and the article by Van Steenkiste, et al. entitled “Kinetic Spray Coatings” published in Surface and Coatings Technology Volume III, Pages 62-72, Jan. 10, 1999, all of which are herein incorporated by reference. The kinetic spray technique as used in certain embodiments of the invention utilizes an improved nozzle system as compared to those systems described in the foregoing documents. Although the following description refers to the kinetic spray system utilizing an improved nozzle system, other kinetic spray systems may be useful in practicing the invention described herein.

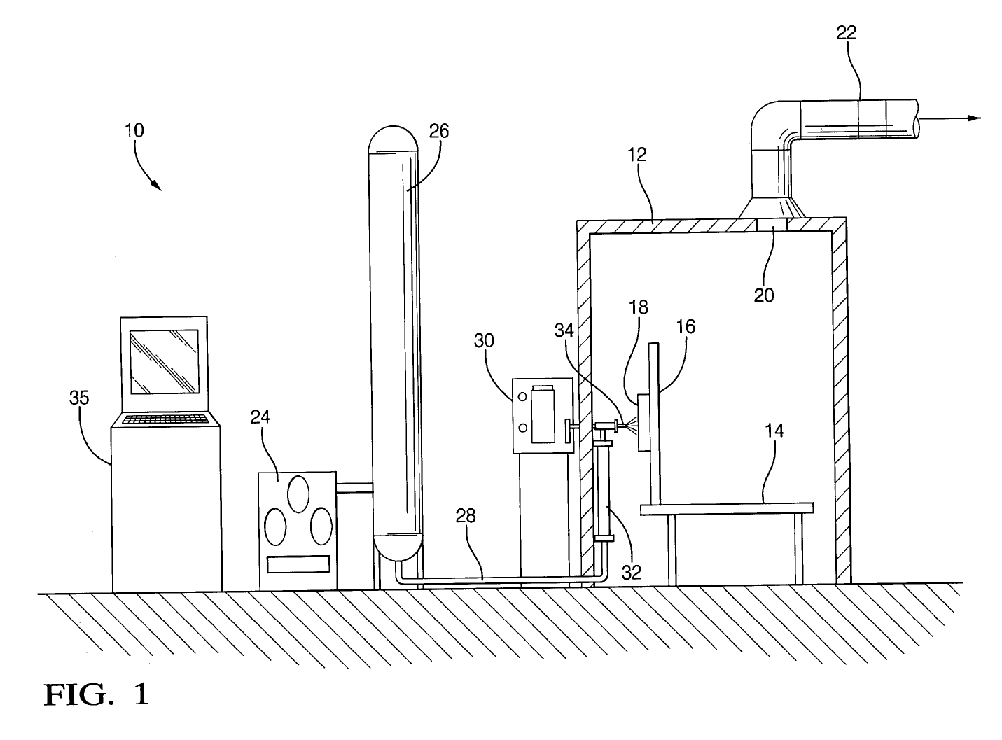

Referring first to FIG. 1, a kinetic spray system for use in accordance with particular aspects of the present invention is generally shown at 10. System 10 includes an enclosure 12 in which a support table 14 or other support means is located. A mounting panel 16 fixed to the table 14 supports a work holder 18 for holding the substrate to be coated. In one embodiment, the work holder 18 is capable of movement in three dimensions and is able to support a suitable substrate to be coated. In another embodiment, the work holder 18 is capable of feeding a substrate to be coated past a kinetic spray nozzle 34, described below. The enclosure 12 includes surrounding walls having at least one air inlet, not shown, and an air outlet 20 connected by a suitable exhaust conduit 22 to a dust collector, not shown. During coating operations, the dust collector continually draws air from the enclosure 12 and collects any dust or particles contained in the exhaust air for subsequent disposal.

The spray system 10 further includes an air compressor 24 capable of supplying air pressure up to 3.4 MPa (500 psi) to a high pressure air ballast tank 26. The air ballast tank 26 is connected through a line 28 to both a high pressure powder feeder 30 and a separate air heater 32. The air heater 32 supplies high pressure heated air, the main gas described below, to a kinetic spray nozzle 34. The temperature of the main gas can vary from about 100 to 3000° C., depending on the powder or powders being sprayed. The pressure of the main gas and the powder feeder 30 varies from 200 to 500 psi. The powder feeder 30 mixes particles of a single powder or a mixture of particles with unheated high-pressure air and supplies the particle mixture to a supplemental inlet line 48 of the nozzle 34. The particles utilized in the present invention comprise composite particles that include a corrosion protector, a brazing filler and a brazing flux material. A computer control 35 operates to control both the pressure of air supplied to the air heater 32 and the temperature of the heated main gas exiting the air heater 32. As would be understood by one of ordinary skill in the art, the system 10 can include multiple powder feeders 30, all of which are connected to one or more supplemental feedline(s) 48. For clarity only one powder feeder 30 is shown in FIG. 1.

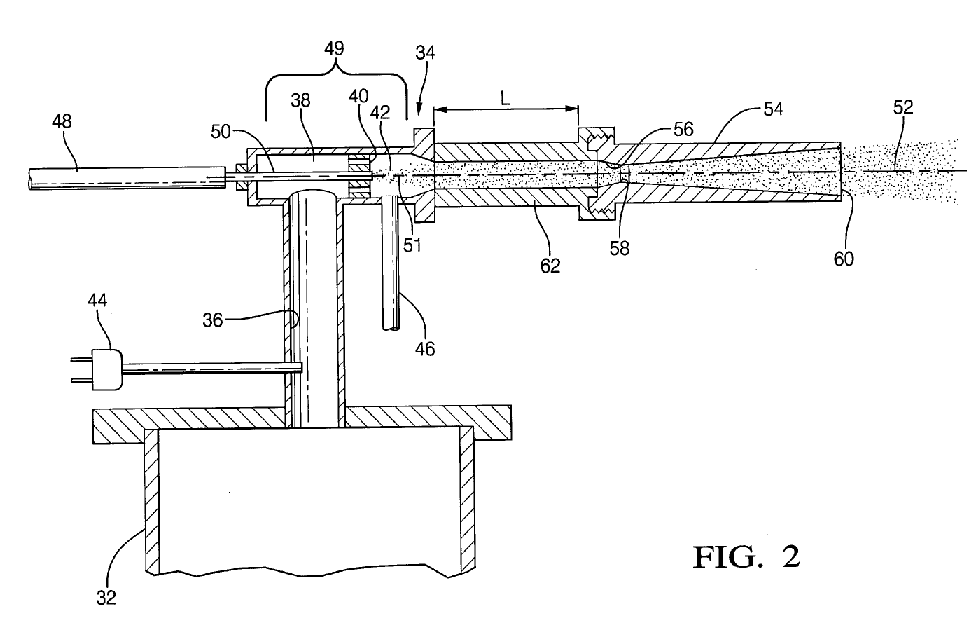

FIG. 2 is a cross-sectional view of the nozzle 34 and its connections to the air heater 32 and the supplemental inlet line 48. A main air passage 36 connects the air heater 32 to the nozzle 34. Passage 36 connects with a premix chamber 38 which directs air through a flow straightener 40 and into a mixing chamber 42. Temperature and pressure of the air or other heated main gas are monitored by a gas inlet temperature thermocouple 44 in the passage 36 and a pressure sensor 46 connected to the mixing chamber 42. The premix chamber 38, flow straightener 40, and mixing chamber 42 form a gas/powder exchange chamber 49.

A mixture of high pressure gas and coating powder is fed through the supplemental inlet line 48 to a powder injector tube 50 having a central axis 52 which, in accordance with particular embodiments, is the same as a central axis 51 of the gas/powder exchange chamber 49. In accordance with certain kinetic spray systems, the length of chamber 49 is between about 40-80 mm. Preferably, the injector tube 50 has an inner diameter of from about 0.3 to 3.0 millimeters. The tube 50 extends through the premix chamber 38 and the flow straightener 40 into the mixing chamber 42.

Mixing chamber 42 is in communication with the de Laval type nozzle 54. The nozzle 54 has an entrance cone 56 that decreases in diameter to a throat 58. Downstream of the throat is an exit end 60. The largest diameter of the entrance cone 56 typically may range from 10 to 6 millimeters, with 7.5 millimeters being particularly useful. The entrance cone 56 narrows to the throat 58. In accordance with certain embodiments, the throat 58 may have a diameter of from about 4.5 to 1.5 millimeters, more particularly from about 3 to 2 millimeters. The portion of the nozzle 54 from downstream of the throat 58 to the exit end 60 may have a variety of shapes, but in a specific embodiment it has a rectangular cross-sectional shape. At the exit end 60, the nozzle 54 preferably has a rectangular shape with a long dimension of from about 8 to 16 millimeters by a short dimension of from about 2 to 6 millimeters. In accordance with particular embodiments, the distance from the throat 58 to the exit end 60 may vary from about 60 to 400 millimeters.

In accordance with the spray nozzle shown in FIG. 2, a powder/gas conditioning chamber 62 is positioned between the gas/powder exchange chamber 49 and the supersonic nozzle 54. The powder/gas conditioning chamber 62 has a length L along its longitudinal axis. The axis 52 is the same as axis 51 in this embodiment. Preferably the interior of the powder/gas conditioning chamber 62 has a cylindrical shape. Also preferably its interior diameter matches the entrance of the converging portion of the spray nozzle. The powder/gas conditioning chamber 62 releasably engages both the supersonic nozzle 54 and the gas/powder exchange chamber 49. Preferably, the releasable engagement is via correspondingly engaging threads on the gas/powder exchange chamber 49, the nozzle 54, and the powder/gas conditioning chamber 62 (not shown). The releaseable engagement could be via other means such as snap fits, bayonet-type connections and others known to those of skill in the art. The length L along the longitudinal axis is preferably at least about 20 millimeters or longer. The optimal length of the powder/gas conditioning chamber 62 depends on the particles that are being sprayed and the substrate that is being sprayed with the particles. The optimal length L can be determined experimentally. Preferably the length L ranges from about 20 to 1000 millimeters. It has been found that by including a powder/gas conditioning chamber 62 one can achieve dramatic increases in deposition efficiency and the ability to deposit particles, such as the composite particles described herein, that previously were not able to be deposited. Note that with the insertion of the powder/gas conditioning device 62, the distance between the exit of the injector tube 50 and the adjacent end of spray nozzle 54 is significantly increased as compared to conventional spray nozzles such as those described in U.S. Pat. Nos. 6,139,913 and 6,283,386. Therefore the powder/gas conditioning chamber 62 allows for a longer residence time of the particles in the main gas prior to entry into the supersonic nozzle 54. This longer residence time leads to a higher particle temperature, more homogeneous main gas powder intermixing, and a more homogeneous flow of the gas powder mixture. Thus, the particles will achieve a higher temperature, closer to but still below their melting point, prior to entry into the supersonic nozzle 54. Particle temperatures from about 200° C. to about 500° C., more particularly from about 300° C. to about 450° C., can be achieved using a nozzle 34 containing a powder/gas conditioning chamber 62. The thermal energy of sprayed particles are obtained primarily in the chamber 62 where the particles travel through the gas stream with the highest temperatures. With the introduction of chamber 62, a wider range of hard materials becomes sprayable with relatively high deposition efficiencies. The composite powder of braze alloys and braze flux, which is used in this invention, is one of such materials.

As disclosed in U.S. Pat. Nos. 6,139,913 and 6,283,386 the powder injector tube 50 supplies a particle powder mixture to the system 10 under a pressure in excess of the pressure of the heated main gas from the passage 36. The nozzle 54 produces an exit velocity of the entrained particles of from 200 meters per second to as high as 1300 meters per second. The entrained particles gain kinetic energy during their flow through this nozzle 54. Since they are already bestowed thermal energy through chamber 62 (i.e. before entering the nozzle 54), the particles possess comparable thermal energy and kinetic energy as they collide with the substrate to form a coating. It will be recognized by those of skill in the art that the temperature of the particles in the gas stream will vary depending on the particle size and the main gas temperature. The main gas temperature is defined as the temperature of heated high-pressure gas at the inlet to the nozzle 54. The main gas temperature can be substantially above the melting temperature of the particles being sprayed. In fact, the main gas temperature can vary from about 100 to about 3000 degrees Celsius, more particularly from about 200 to 1000 degrees Celsius or as high as 7 fold above the melting point of the particles being sprayed depending on the particle material. Despite these high main gas temperatures the particle temperature is at all times significantly lower than the melting point of the particles. This is because the powders are injected into the heated gas stream by the unheated powder gas and the exposure time of the particles to the heated main gas is very short. In other words, the particle energy at the exit of nozzle 34 is predominantly kinetic energy. Therefore, even upon impact there is no change in the solid phase of the original particles due to transfer of kinetic and thermal energy, and no change in their original physical properties. The particles are always at a temperature below their melting point. The particles exiting the nozzle 54 are directed toward a surface of a substrate to coat it.

Upon striking a substrate opposite the nozzle 54 the particles flatten into a nub-like structure with an aspect ratio of generally about 5 to 1. When the substrate is a metal or alloy and the particles include a metal or an alloy, all the particles striking the substrate surface fracture the surface oxide layer and the metal or alloy particles subsequently form a direct metal-to-metal bond between the particle and the substrate. Upon impact the kinetic sprayed particles transfer substantially all of their kinetic and thermal energy to the substrate surface and stick if their yield stress has been exceeded. As discussed above, for a given particle to adhere to a substrate it is necessary that it reach or exceed its critical velocity which is defined as the critical velocity at which it will adhere to a substrate when it strikes the substrate after exiting the nozzle 54. This critical velocity is dependent on the material composition of the particle. In general, harder materials must achieve a higher critical velocity before they adhere to a given substrate. It is not known at this time exactly what is the nature of the particle to substrate bond; however, it is believed that a portion of the bond is due to the particles plastically deforming upon striking the substrate.

In the construction of a heat exchanger comprising fins and tubes, an extruded aluminum condenser tube is prepared for brazing aluminum fins thereon by kinetic spraying a brazing composition on the tube or other surface. The brazing composition comprises composite particles of corrosion protector, filler material, and flux.

The brazing composition typically comprises composite particles having an average particle size (diameter or equivalent) in the range of about several microns to about 200 microns. The composite particles in accordance with particular embodiments have an average particle size of at least about 10 microns, more particularly at least about 50 microns and still more particularly at least about 65 microns. The composite particles in accordance with certain embodiments have an average particle size not greater than about 150 microns, more particularly not greater than about 106 microns and still more particularly not greater than about 100 microns. The particles may further be either spherical or irregular shaped (such as granular).

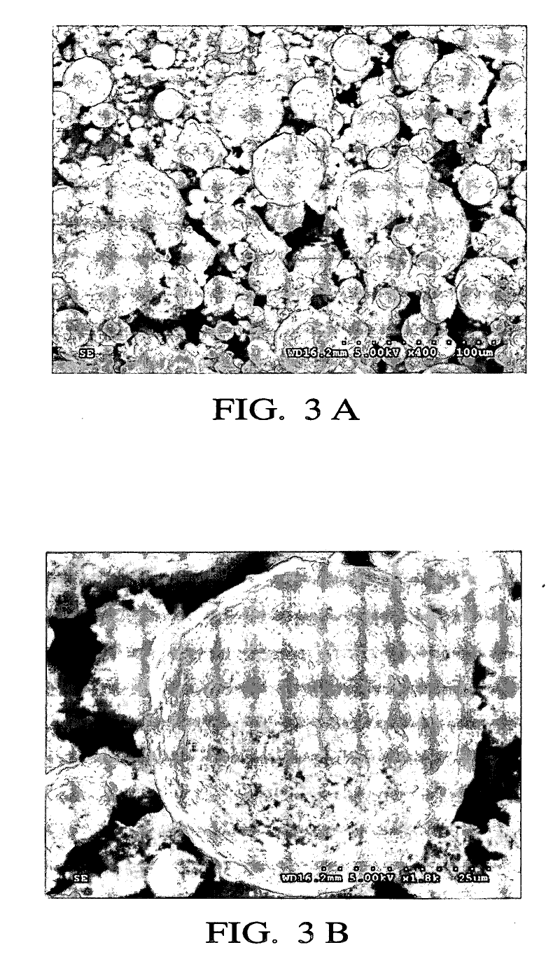

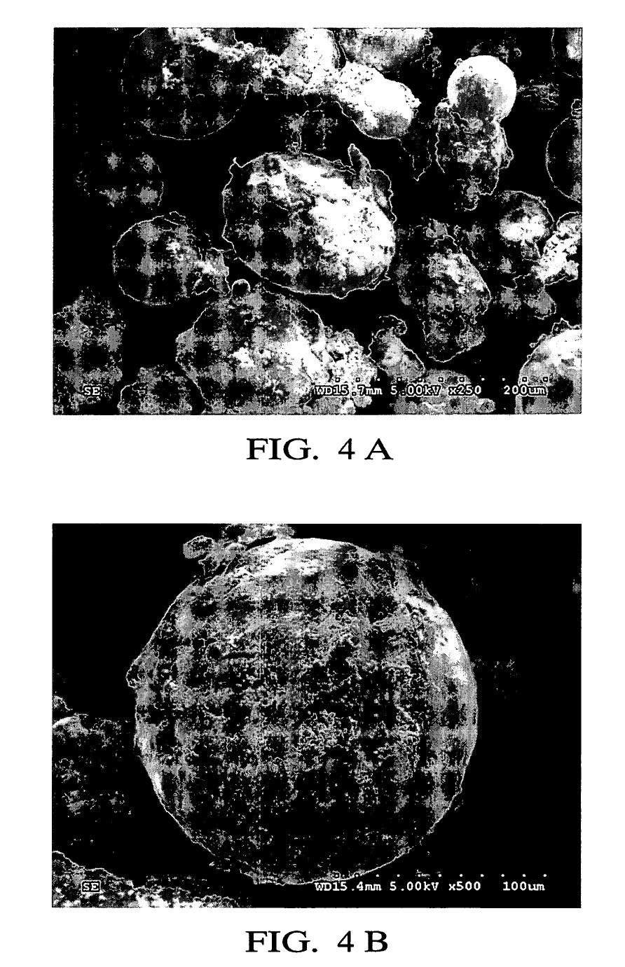

The composite particles useful in the present invention include those in which the filler alloy (including Zn) and braze flux are premixed together prior to being applied to the substrate using the kinetic spray process. The composite particles that can be used as feedstocks for the kinetic spray process include the following types of particles: a) composite particles prepared from a substantially uniform mixture of the filler alloy, corrosion protector and flux as shown in FIG. 3; and b) composite particles comprising a core containing the filler alloy (including the corrosion protector) and a coating on the core wherein the coating comprises the brazing flux as shown in FIG. 4.

Composite particles comprising a substantially uniform mixture of filler alloy, corrosion protector and flux may be prepared by any method suitable for providing a relatively homogeneous mixture. A particularly useful method for forming composite particles in accordance with this aspect of the invention is by gas atomization. Gas atomization involves pouring molten alloy through a compressed gas stream that breaks up the molten alloy into droplets. The droplets solidify as they drop into a catch basin. The resulting composite particles contain the flux incorporated into individual particles of the filler alloy and corrosion protector. FIGS. 3A and 3B illustrate the morphology of Zn—Al—Si powder at low and high magnifications. The composite powders were prepared by gas atomization, so that the flux is incorporated into the Zn—Al—Si filler alloy.

Composite particles comprising flux on an alloy core or alloy on a flux core can also be prepared using any method suitable for forming the core and attaching other materials to the core surface. The brazing flux may be adhered to the core using any conventional technique for bonding flux onto the core particles. In accordance with a certain embodiment, the flux is bonded onto the surface of the core particles using an adhesive. Since the adhesive cannot impede the functional integrity of brazing flux and adversely affect braze joint formation during brazing operation, the preferred adhesives are those that become volatile and decomposed at the temperatures below brazing temperatures. For example, either acrylic resins or methacrylic resins can be used as an adhesive to bond flux to alloy powders.

Examples of alloys useful in forming the composite particles include zinc-aluminum alloy, aluminum-silicon alloy, aluminum-zinc-silicon alloy and aluminum-zinc-silicon-copper alloy. It is preferred that a non-corrosive flux, such as NOCOLOK® flux or the like, be incorporated in the filler alloy composition or coated on the filler alloy core to form composite particles useful in preparing the brazing composition to be used.

In the present invention, the brazing composition is introduced into a focused gas stream traveling at a velocity of about 300 m/s (meters per second) to about 1000 m/s. The gas stream in accordance with particular embodiments may be preheated to a temperature of from about 100° C. to about 800° C., and more particularly to at least about 600° C. As the particles of the brazing composition are entrained into the gas stream and through the PCD, they begin to gain kinetic and thermal energy. The brazing composition is then accelerated through a de Laval-type nozzle to achieve an exit velocity of up to about 1000 m/s directed toward the tube surface (i.e., the substrate being sprayed). The tube is moved across the path of the exit stream (or vice versa) to lay a coating on the surface of the tube. The tube is passed across the exit stream as necessary to create one or more layers. The coating process described herein can be implemented in-line with the fabrication processes of condenser tubes, thereby further reducing production costs.

As particles of the brazing composition impact the surface, kinetic energy is transferred to the aluminum surface. The impact of the particles initially grit blast the surface thereby fracturing any surface oxide layer, and simultaneously begin mechanically deforming and impingement bonding the particles to the surface. Successive layers are formed by the entrained particles impacting and bonding to other particles deposited on the surface. The particles deposited on the surface while undergoing plastic deformation remain in their original solid phase (i.e., there is no chemical reaction between different ingredients, no phase transformation and no melting).

An aluminum substrate made according to the invention comprises an aluminum surface and a kinetically impinged coating bonded to its surface. The coating comprises a corrosion protector for aluminum, a filler material for brazing, and brazing flux. The coating may have multiple layers kinetically bonded directly to the aluminum surface. In accordance with particular embodiments, each layer is substantially free of oxides and retains the physical properties and solid phase of the original pre-coating composition. The braze coating may be applied to one or both of the substrates to be brazed together. The amount of braze material required may vary according to the size of the joint gap between the substrate. In general, the braze coating is applied in the amount needed to ensure adequate fusion of the substrate surfaces. The amount of braze coating typically will be between about 20 g/m² and 100 g/m². The aluminum alloy substrate (for example, either a braze sheet or condenser tubes) may be heated to further promote particle-substrate bonding and deposition efficiency. The substrate in accordance with particular embodiments may be heated to a temperature between about 40° and 200° C.

According to the present invention, the following coatings were prepared, kinetically sprayed onto aluminum brazing substrates and brazed. While representative of the present invention, the following examples are not intended to limit the scope of the invention in any way.

### EXAMPLES

As described above, this invention involves a single coating deposition by the kinetic spray process. FIG. 2 shows a kinetic spray nozzle system used for coating deposition using composite powders. The coating includes both the NOCOLOK® Flux and the ternary alloy Zn—Al—Si. The composite powders were prepared using a gas atomization process. During the process, both the alloying elements of the alloy such as zinc, aluminum, silicon and the brazing flux powder were incorporated into individual particles of the composite. A particularly useful particle size distribution as the feedstock powder for the kinetic spray process is between about 10 microns to about 106 microns. The coating was deposited at the following conditions:
Primary gas temperature: 620° C. (1150° F.)
Primary gas pressure: 285 psi
Primary gas flow: 60 cfm
Powder feeder gas flow: 8 cfm
Powder feedrate: 1.4 g/s
Traverse speed: 32 in/s
PCD length: 400 mm

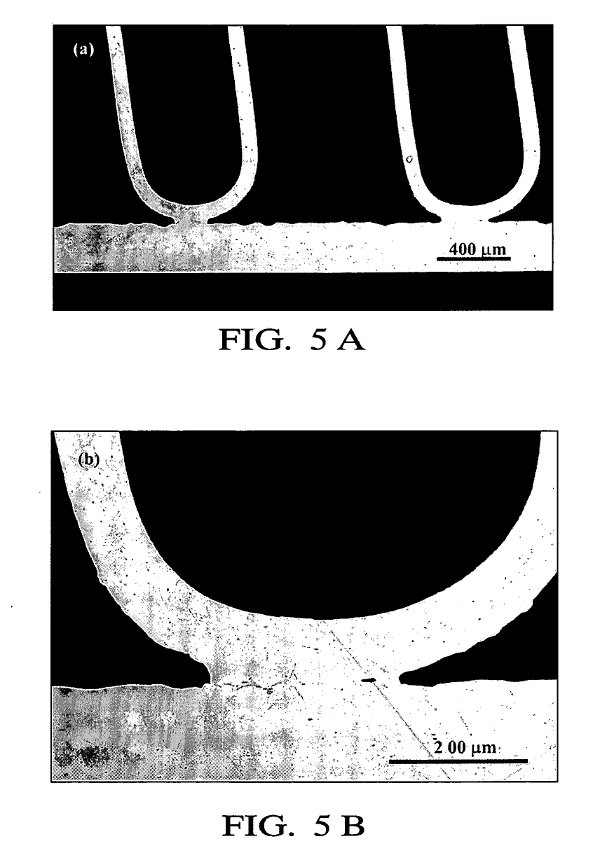

FIG. 5 shows the cross-section of some braze joints. It can be seen that the composite coating with very light loading led to formation of some braze joints. This indicates that there is an adequate amount of flux incorporated into the coating during the coating deposition to enable wetting/flow of the filler alloy.

The results further showed that there was no significant dependence of brazing results based upon variations in the tested compositions or the average coating thickness (i.e. the loading of a coating).

FIGS. 5A and 5B show examples of the brazing joints produced using the controlled atmospheric brazing (CAB) process at 600° C. Since silicon is a rapid diffuser in aluminum, the incorporation of silicon helps the melting of aluminum during the brazing process. As a result, good brazability was achieved for the composite coatings (alloy of aluminum-zinc-silicon, plus braze flux).

With the composite coatings of zinc and aluminum-silicon alloy with directly incorporated flux, good brazability was achieved without pre-fluxing the test assembly.

For both composite coatings of aluminum and zinc, and composite coatings of aluminum alloy and zinc, zinc was incorporated into the coatings primarily to promote coating formation as a binder and to enhance corrosion resistance. Because of the volatile nature of zinc, some loss of zinc during the brazing process is expected.

Coatings of-aluminum-zinc-silicon alloy: The coatings exhibited superior brazing properties. With alloy coatings, it was found that a continuous layer coating was not required to achieve satisfactory brazing results. It was also found that the zinc was uniformly distributed in the coating, which is more desirable for corrosion protection. The results of a SWAAT test (a standard corrosion test for condensers) indicates that the assemblies brazed with aluminum-zinc-silicon alloys can have the corrosion performance equivalent to or better than a product produced using the prior art.

While a particular embodiment of the present invention has been described so as to enable one skilled in the art to practice the process of preparing aluminum surfaces for brazing, it is to be understood that variations and modifications may be employed without departing from the concept and intent of the present invention as defined by the following claims. The preceding description is intended to be exemplary and should not be used to limit the scope of the invention. The scope of the invention should be determined only by reference to the following claims.

What is claimed is:

1. A process for depositing a brazing composition on a substrate comprising:
a) providing a brazing composition comprising a plurality of composite particles, the composite particles comprising a corrosion protector, a filler material for brazing, and a brazing flux;
b) introducing said brazing composition into a focused gas stream;
c) entraining said brazing composition in said gas stream;
d) accelerating said brazing composition in said gas stream toward said substrate; and
e) depositing said brazing composition onto said substrate to form a brazing surface.

2. The process of claim 1 wherein said brazing composition comprises an alloy selected from the group consisting of an aluminum-silicon alloy and an aluminum-zinc-silicon alloy.

3. The process of claim 2 wherein said alloy comprises a ternary mixture of aluminum, zinc and silicon.

4. The process of claim 1 wherein the composite particles comprise a substantially homogeneous blend of the corrosion protector, the filler material for brazing, and the brazing flux.

5. The process of claim 1 wherein the composite particles comprise a core comprising the filler material and the corrosion protector wherein the brazing flux is adhered on the surface of the core.

6. The process of claim 5 wherein said core comprises a ternary mixture of aluminum, zinc and silicon.

7. The process of claim 6 wherein said brazing flux comprises potassium fluoraluminate salts.

8. A brazable aluminum substrate comprising an aluminum surface and a kinetically impinged coating bonded thereon, wherein said coating comprises composite particles, wherein said composite particles comprise a corrosion protector for aluminum, filler material for brazing, and brazing flux having at least one layer kinetically bonded to said aluminum surface.

9. The substrate of claim 8, wherein said coating is mechanically applied to said aluminum surface by a process in which said pre-coating composition is accelerated in a gas stream traveling at a velocity of about 300 to about 1000 meters per second

10. The substrate of claim 9, wherein said coating is present on said substrate in an amount from about 20 g/m² to about 100 g/m².

11. The substrate of claim 8 wherein said brazing coating comprises an alloy selected from the group consisting of zinc-aluminum alloy and aluminum-zinc-silicon alloy.

12. The substrate of claim 11 wherein said alloy comprises a ternary mixture of aluminum, zinc and silicon.

13. The substrate of claim 8 wherein said brazing composition comprises a plurality of layers comprising said composite particles.

14. The substrate of claim 13 wherein said brazing flux comprises potassium fluoraluminate salts.

15. A method of brazing comprising:
a) providing a metal surface;
b) providing a brazing composition comprising a plurality of composite particles, wherein the composite particles comprise a corrosion protective material, a brazing filler material and a brazing flux; and
c) kinetically spraying said brazing composition onto said metal surface.

16. The method of claim 15, wherein said composite particles comprise a core containing aluminum, zinc and silicon wherein the core is coated with the flux.

17. The method of claim 16, wherein said metal surface is aluminum.

18. The method of claim 15 wherein said composite particles are kinetically sprayed at a temperature of from about 200° C. to about 500° C.

19. The method of claim 15 wherein step c comprises:
injecting the composite particles into a focused gas stream;
entraining said composite particles in said gas stream; and
directing the composite particles into a powder/gas conditioning chamber where said composite particles reach a temperature of about 200° C. to about 500° C.

20. The method of claim 19 wherein the gas stream is at a temperature of from about 200° C. to 1000° C.
